(19) United States
(12) Patent Application Publication
(10) Pub. No.: US 2011/0245115 A1
(43) Pub. Date: Oct. 6, 2011

(54) Mechanical Component with a Coated Running Surface

(76) Inventors: Yefim Epshetsky, Schaumburg, IL (US); Alex Paykin, Buffalo Grove, IL (US)

(21) Appl. No.: 13/063,370

(22) PCT Filed: Sep. 10, 2009
(86) PCT No.: PCT/US09/05109

§ 371 Date: Apr. 29, 2011

Related U.S. Application Data
(60) Provisional application No. 61/191,625, filed on Sep. 10, 2008.

(51) Int. Cl. F16C 33/02; B32B 7/02; B32B 5/16

(52) U.S. Cl. 508/100; 428/143; 428/66.4

(57) ABSTRACT

A mechanical component having enhanced tribological characteristics includes a body having at least one surface and a coating layer disposed on the body surface and having an outer surface providing at least a section of a running surface. The layer is formed by directing relatively high velocity particles of a first material toward the body surface such that at least a portion of the first material particles impact the body surface and embed within the body.

The present invention relates to mechanical components, particularly mechanical components having running surfaces.

Mechanical components with one or more running surfaces include any structural member having a surface that is movably engaged by another component. Such components include a shaft seal wear sleeve with an outer circumferential running surface, the inner and outer races of bearings each having a running surface, a piston having an outer sliding surface, etc. To improve the abrasion resistance characteristics and reduce friction, such running surfaces may be coated with a “harder” material(s) applied, for example, in a vapor deposition process. However, such coating processes are often relatively expensive and may therefore be cost prohibitive to use with certain mechanical components.

### SUMMARY OF THE INVENTION

In one aspect, the present invention is a mechanical component having enhanced tribological characteristics. The component comprises a body having at least one surface and a coating layer disposed on the body surface and having an outer surface providing at least a section of a running surface. The layer is formed by directing relatively high velocity particles of a first material toward the body surface such that at least a portion of the first material particles impact the body surface and embed within the body.

In another aspect, the present invention is a mechanical assembly comprising a first mechanical component including a body having at least one surface and a coating layer disposed on the body surface and having an outer surface providing at least a section of a running surface. The layer is formed by directing relatively high velocity particles of a first material toward the body surface such that at least a portion of the first material particles impact the body surface and embed within the body. A second mechanical component is displaceable relative to the first component such that at least a portion of the second component movingly engages with the coating layer surface of the first mechanical component.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a mechanical component in accordance with the present invention, the component being formed as a tubular wear sleeve;

FIG. 2 is an enlarged, axial cross-sectional view through the component, shown mounted on a shaft and engaged by a sealing member;

FIG. 3 is a greatly enlarged, broken-away radial cross-sectional view through the mechanical component; and

FIG. 4 is a broken-away, even more greatly enlarged cross-sectional view of the mechanical component, depicting the coating in exaggerated detail and indicating the process of forming a coating layer on the component.

### DETAILED DESCRIPTION OF THE INVENTION

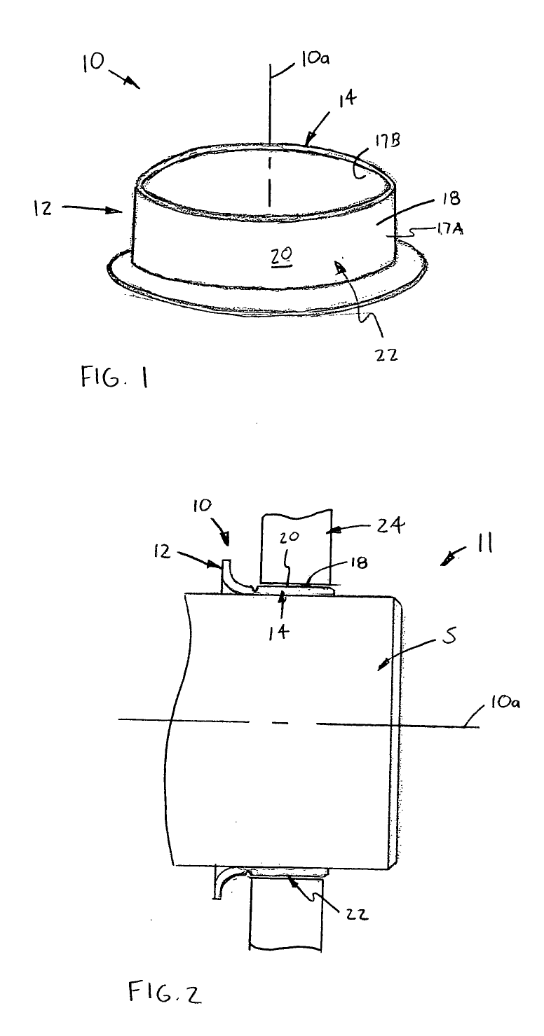

Referring to the drawings in detail, wherein like numbers are used to indicate like elements throughout, there is shown in FIGS. 1-4 a mechanical component 10 having enhanced tribological characteristics in accordance with the present invention, the specific construction of the component illustrated being a generally tubular wear sleeve 12. The mechanical component 10 basically comprises a body 14 having at least one surface 16 and a coating layer 18 disposed on the body surface 16. The coating layer 18 has an outer surface 20 providing at least a section of a running surface 22, preferably the entire running surface 22. As used herein, the term “running surface” is used to indicate any surface for supporting sliding and/or rolling motion of another or second component 24 relative to the first component 10, as discussed in greater detail below. Further, the coating layer 18 is formed by directing relatively high velocity particles 26 of a first material M₁ toward the body surface 16 such that at least a portion of the first material particles 26 impact the body surface 16 and embed within the body 14.

Referring particularly to FIG. 4, the first material particles 26 travel at a relatively high velocity and impact the surface 16 such that the particles both embed in the body 14 beneath the surface 16 and transfers kinetic energy to the body 14. The body 14 is formed of a second material M₂, and the impact of at least a portion of the first material particles 26 with the body surface 16 causes portions 15 of the body 14 to displace. More specifically, the kinetic energy transferred to the body 14 by the particles 26 cause the body portions 15 to melt, then flow or splatter, and subsequently harden at a position other than an original location on the body 14. As such, the coating layer 18 has an inner section 19A that includes a mixture of the second material body portions 15 and the first material particles 26. By having an inner section 19A formed of the mixture of displaced body portions 15 and particles 26, the coating layer 18 is more strongly bonded or adhered to the component body 14 in comparison with coating layers formed by prior art techniques such as vapor deposition, etc. Further, the coating layer 18 also includes an outer section 19B that is substantially formed of the first material particles 26 and which provides the coating outer surface 20.

Still referring to FIG. 4, the first material particles 26 are preferably nanoparticles, specifically particles sized between one (1) and twenty-five hundred (2500) nanometers, most preferably having a diameter or/and length between five (5) and thirty-five (35) microns. As such, the coating layer outer surface 18 has substantial porosity so as to increase absorption of lubricant materials by the coating outer surface 20. That is, by forming the coating layer 18 using nanoparticles, the coating outer surface 20 tends to more closely follow or mimic the contour of the body surface 16 or “substrate” and also creates capillaries or cavities C between the nanoparticles, which provide space for absorption of a lubricant, as best shown in FIG. 4. With an outer surface 20 having such capillaries/cavities C, liquids such as lubricants tend to “pool” on the surface 20 and thus improve the “wetability” and oil retention of the coated running surface 22.

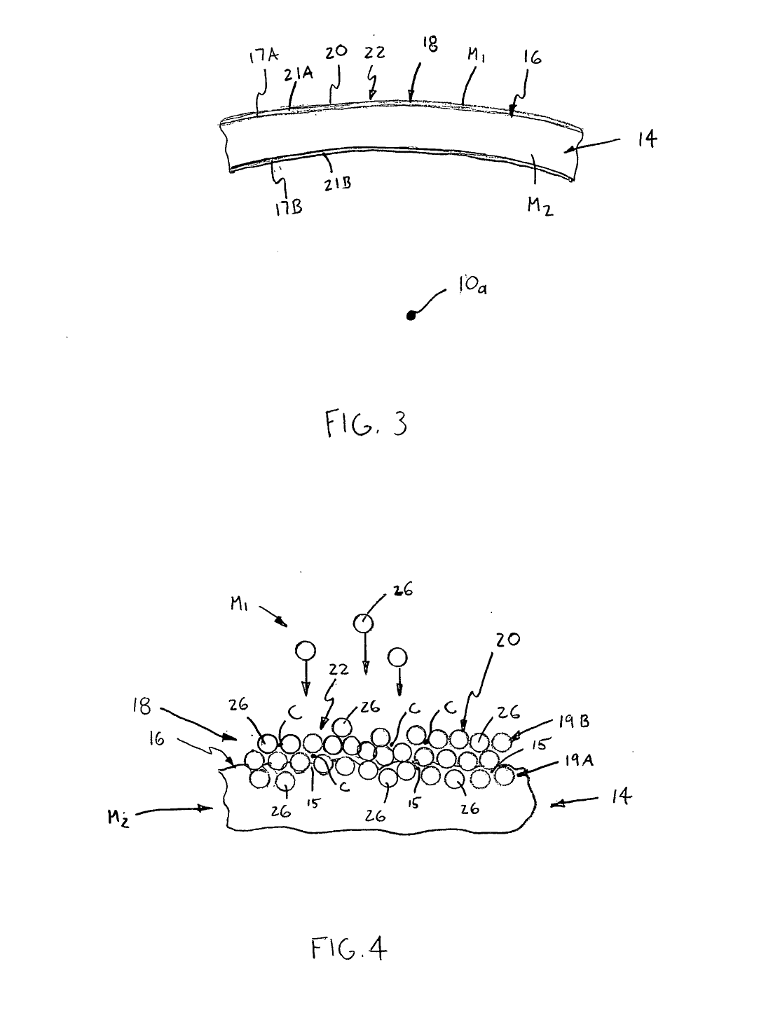

Referring now to FIGS. 1 and 3, the one or more body surfaces 16 on which the coating 18 is applied is preferably curved, such that each coating layer 18 is also curved. More specifically, each body surface 16 is preferably either an outer circumferential surface 17A or an inner circumferential surface 17B, and each coating layer 18 is disposed on the outer or inner surfaces 17A, 17B such that the layer 18 extends at least partially circumferentially about the body 14. That is, the body 14 may include at least one outer circumferential surface 17A and at least one inner circumferential surface 17B, with the component 10 including both a first coating layer 21A disposed on one of the inner and outer body surfaces 17A, 17B and a second coating layer 21B disposed on the other one of the surfaces 17A, 17B. With such circumferential surfaces 17A, 17B, the coating layer 18 is preferably applied in a process which includes the step of rotating the body 14 about a central axis as the particles 26 are continuously directed toward and onto the body outer surface(s) 17A and/or 17B, as indicated in FIGS. 3 and 4, to thereby form one or more coating layers 18 that are each relatively homogenous. Alternatively, the device (not depicted) which emits or accelerates the particles 24 may alternatively be rotated about a stationary body 14. Further, the body 14 may include any number of surfaces 16 on which it is desired to provide a running surface 22, such that the component 10 includes one or more coating layers 18 on each such body surface 16, and/or the body surface(s) 16 and coating layer(s) 18 may alternatively be substantially flat.

In any case, the coating layer outer surface 20 has a hardness greater than a hardness of any surface of the body 14. As such, wear, friction, and other tribological characteristics of the body surface 16 are greatly improved (i.e., in comparison to the uncoated surface 16).

Preferably, the first material M₁ is or includes titanium nitride (“TiN”), but may alternatively be formed of chromium, nickel, tungsten carbide, titanium carbide, silicon carbide, aluminum boride, etc., or any other appropriate material.

Referring particularly to FIGS. 1 and 2, as discussed above, in a presently preferred embodiment, the body 14 includes a general tubular wear sleeve 12 configured to be disposed upon a shaft S (FIG. 2), such as in seal assembly incorporated in an automotive hub assembly (neither shown). However, the mechanical component 10 may be part of any mechanical assembly 11 that comprises the component 10 and a second mechanical component 24, such as a sealing member. The second component 24 is displaceable relative to the first component 10 (i.e., at least one component 10 and/or 24 actually displaces), such that at least a portion of the second component 24 movingly engages with the coating layer surface 20 of the first mechanical component 10. Preferably, the first component 10 has a central axis 10a and the second component 24 is either rotationally displaceable about the axis 10a, linearly displaceable along the axis 10a, and/or reciprocally displaceable rotationally about the axis 10a and/or linearly along the axis 10a. Such a mechanical assembly 11 may include two first components, such as inner and outer bearing races, and the second components may include a plurality of rolling elements, such as balls or rollers.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A mechanical component having enhanced tribological characteristics, the component comprising:
a body having at least one surface; and
a coating layer disposed on the body surface and having an outer surface providing at least a section of a running surface, the layer being formed by directing relatively high velocity particles of a first material toward the body surface such that at least a portion of the first material particles impact the body surface and embed within the body.

2. The component as recited in claim 1 wherein the body is formed of a second material and the impact of at least a portion of the first material particles with the body surface displaces portions of the body such that the coating layer has an inner section including a mixture of the second material body portions and the first material particles.

3. The component as recited in claim 2 wherein the coating layer includes an outer section substantially formed of the first material particles and providing the coating outer surface.

4. The component as recited in claim 1 wherein the first material particles are nanoparticles such that the coating layer outer surface has substantial porosity so as to increase absorption of lubricant materials by the coating outer surface.

5. The component as recited in claim 1 wherein the first material particles have at least one of a diameter and a length within about five microns and about thirty-five microns.

6. The component as recited in claim 1 wherein the body surface is curved.

7. The component as recited in claim 6 wherein the body surface is one of an outer circumferential surface and an inner circumferential surface and the coating layer is disposed on the one of the inner and outer surfaces such that the layer extends at least partially circumferentially about the body.

8. The component as recited in claim 1 wherein the body includes at least one inner circumferential surface and at least one outer circumferential surface, the coating layer is a first coating layer disposed on one of the inner and outer body surfaces, and the component further comprises a second coating layer disposed on the other one of the inner and outer body surfaces.

9. The component as recited in claim 1 wherein the coating layer outer surface has a hardness greater than a hardness of any surface of the body.

10. The component as recited in claim 1 wherein the first material includes at least one of titanium nitride, chromium, and nickel.

11. The component as recited in claim 1 wherein the body includes a general tubular sleeve configured to be disposed upon a shaft.

12. The component as recited in claim 1 wherein the coating outer surface is configured for at least one of sliding contact and rolling contact with another mechanical component.

13. A mechanical assembly comprising:
a first mechanical component including a body having at least one surface and a coating layer disposed on the body surface and having an outer surface providing at least a section of a running surface, the layer being formed by directing relatively high velocity particles of a first material toward the body surface such that at least a portion of the first material particles impact the body surface and embed within the body; and
a second mechanical component displaceable relative to the first component such that at least a portion of the second component movingly engages with the coating layer surface of the first mechanical component.

14. The mechanical assembly as recited in claim 13 wherein the first component has a central axis and the second component is one of rotationally displaceable about the axis, linearly displaceable along the axis, and reciprocally displaceable at least one of rotationally about the axis and linearly along the axis.
